(19) United States
(12) Patent Application Publication
(10) Pub. No.: US 2013/0347004 A1
(43) Pub. Date: Dec. 26, 2013

(54) CORRELATING MESSAGES

(71) Applicants: Rouven Day, Waghausel (DE); Martin Moeller, Sandhausen (DE); Volker Lehmann, Leimen (DE)

(72) Inventors: Rouven Day, Waghausel (DE); Martin Moeller, Sandhausen (DE); Volker Lehmann, Leimen (DE)

(73) Assignee: SAP AG, Walldorf (DE)

(21) Appl. No.: 13/531,829

(22) Filed: Jun. 25, 2012

(51) Int. Cl. G06F 9/54

(52) U.S. Cl. 719/313

(57) ABSTRACT

The present disclosure describes methods, systems, and computer program products for correlating messages. The method can include identifying a message received at an end point associated with executing business process instances. Attributes of the message are identified. The message can be associated with a defined set of relevant attributes associated with a correlation condition of business process instances associated with the end point. A message context fingerprint hash calculated using the attributes of the identified message is generated. The message context fingerprint hash is uniquely associated with the identified message and compared to a number of business process instance fingerprint hashes. The business process instance fingerprint hashes can be generated from a number of business process instance associated with the end point. The identified message associated with the message context fingerprint hash can be correlated with the business process instance associated with the matching hashed business process instance fingerprint hash.

### BACKGROUND

In many instances, business process management systems (BPMS) can send out and receive messages between process instances for intra-/inter-process communications. The BPMS may “catch” the events related to sending and/or receiving the messages. For example, within a process definition, there can be integration points that are depicted by catching message events. One example for the catching message event can be an intermediate message event (IME). In this example, a business process instance can include an initiation, an interaction (e.g., with a human operator), an IME reception, and an endpoint, among others. For the business process instance to continue in its control flow in response to a received message, certain conditions may be required to be met. The conditions can include receiving the message at the endpoint the IME is listening to, and determining a true status for a correlation condition.

In some situations, the correlation condition may be applied to messages fitting a certain context. For example, the correlation conditions can include determining a match for all messages; determining a match between the messages and a constant value; and determining a match between the messages and a dynamic/potential value. The payload (e.g., content) of an incoming message can include not only the data relevant for evaluating the correlation condition, but also business data used for subsequent process execution, causing a high volume requirement depending on business scenarios (e.g., the total data volume can be arbitrarily large). This high volume requirement can cause a long processing time for scanning and comparing the complete message with the process context, impeding the flow of the business process instance that requires a true correlation status.

### SUMMARY

The present disclosure describes methods, systems, and computer-readable media for correlating messages in a business process management system. Incoming messages need a positive correlation condition with process context for successful process flow. The present disclosure can effectively and efficiently perform message correlation. For example, when a message is sent to a BPMS, attributes from the received message can be extracted to focus on a predefined set of attributes associated with a correlation condition of the BPMS instance, thereby reducing the total amount of information to be processed during the correlation determination. In some implementations, correlation conditions may be pre-defined during modeling of business process. The business process attributes to be extracted may be known for the particular process instances at runtime based on the predefined attributes relevant to the corresponding correlation conditions. The attributes for correlation may include one or more types of a string, a number, or a Boolean, among others. These types may be differentiated in the correlation condition, allowing for differentiation between relevant attributes. Further, the position of correlation attribute may be important when the correlation condition includes multiple attributes. In addition, attribute values can be significant to the correlation condition.

The present disclosure provides implementations of correlation condition matching based on fixed length identifiers called fingerprints. These fingerprints can be easily stored in a relational database (e.g., due to small size) and can be compared directly and efficiently with each other. The fingerprints can be uniquely based on combinations of positions, types, and values of a subset of attributes associated with a message, and can be generated using a hash function, under a low probability of collision. The use of the fingerprints in determining message correlation can allow the system to effectively and efficiently evaluate correlation conditions.

In a general aspect, a method for correlating messages can include identifying a message received at an end point associated with at least one executing business process instance. At least one attribute of the identified message is identified. The message can be associated with a defined set of relevant attributes associated with a correlation condition of at least one business process instance associated with the end point. A message context fingerprint containing the at least one identified attribute of the identified message is generated. A hash algorithm can be applied to the message context fingerprint to create a message context fingerprint hash. The message context fingerprint hash is uniquely associated with the at least one identified attribute of the identified message. The message context fingerprint hash can be compared to a number of business process instance fingerprint hashes. The business process instance fingerprint hashes can be generated from a number of business process instance associated with the end point. The identified message associated with the message context fingerprint hash can be correlated with the business process instance associated with the matching hashed business process instance fingerprint hash.

These and other embodiments can each optionally include one or more of the following features. For example, after correlation, the message can be sent to the corresponding business process instance for consumption. The message can be received at a corresponding business process instance. In response to a determination that the control flow of the corresponding business process instance is ready to consume the message, the message context fingerprint hash is compared to the current business process instance fingerprint hash of the corresponding business process instance to confirm a match. In response to a determination that a match is confirmed, the message is consumed at the corresponding business process instance. When a match is not confirmed, the message is discarded. In some implementations, the end point can include a structure defined by an intermediate message event associated with a process definition. The payload of the received message can be provided in an XML schema or web service description language.

These and other embodiments can each optionally include one or more of the following features. In some implementations, the correlation condition can include equality conditions concatenated with a logical operator based on payload and context of the message. The defined set of relevant attributes can be defined by rules for extracting data from the context of the received message. The business process instance fingerprint hashes can be generated into a predetermined format based on position, type and value. The business process instance fingerprint hashes can be defined upon instantiation of the business process instance. The business process instance fingerprint hashes can be recalculated during execution of the business process instance in response to a change to a process context associated with the business process instance.

While generally described as computer-implemented software embodied on tangible and non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for implementing various features of a system for correlating messages.

FIGS. 2A and 2B illustrate example business process models of business process instances.

FIG. 3 illustrates an example method for correlating messages.

FIG. 4 illustrates an example method for determining consumption of messages.

FIG. 5 illustrates an example method for persisting process context fingerprint.

### DETAILED DESCRIPTION

This specification describes systems, methods, apparatus, and computer-readable media for correlating messages in a business process management system (BPMS). Incoming messages need a positive correlation condition corresponding with a particular business process instance's process context for successful correlation and use of the message. The methods described in the present disclosure can effectively and efficiently perform message correlation. For example, when a message is sent to a BPMS, attributes from the received message can be extracted to focus on a predefined set of attributes associated with a correlation condition of the BPMS instance, thereby reducing the total amount of information to be processed during the correlation determination. In some implementations, correlation conditions may be pre-defined during modeling of business process. The business process attributes to be extracted may be known for the particular process instances at runtime based on the predefined attributes relevant to the corresponding correlation conditions. The attributes for correlation may include one or more types of a string, a number, or a Boolean, among others. These types may be differentiated in the correlation condition, allowing for differentiation between relevant attributes. Further, the position of correlation attribute may be important when the correlation condition includes multiple attributes. In addition, attribute values can be significant to the correlation condition

At a high level, the disclosed methods can enable a business process management system to correlate messages. The method can include modeling a process definition with an intermediate message event (IME) at design time. The IME can define the structure for incoming messages; for example, for different formats of the messages (e.g., XML schema, web service description language, etc.). The IME can also define a correlation condition; for example, defining equality conditions involving logical operations, message payload, and process context. In other words, the IME defines the types of messages that it will receive at a particular time. The IME may be associated with a web services endpoint, in some instances. At process instantiation time, correlation condition values can be calculated based on an initial process context of the business process instance, which can be used to define a process context fingerprint for the business process instance. The attributes relevant to the correlation condition can be evaluated for the process context, and the fingerprint of the business process instance can be initially defined. If the process context changes at runtime, the business process instance's fingerprint can be reassessed to provide an updated value against which the corresponding message fingerprints can be compared. The defined correlation conditions can be used at runtime to extract the relevant portions from messages to compare to the values retrieved from the process context. After deployment time (e.g., of the related application including business process), a web service endpoint provided by server can accept the messages having structures defined by the IME, when the IME is associated with that web service endpoint.

At runtime, one or more process instances are initiated or initialized based on the (business) process definition. Input data associated with the instantiated business process can be provided to help define the initial process context. A process instance may receive incoming messages regardless of its progress through the control flow. For example, a particular process instance may be correlated with a message, even if the message is received prior to a time when the message is ready to be processed. For each process instance, the correlation attributes can be extracted from the process context, and process context-related business process instance fingerprints can be calculated based on particular messages attributes, including the attributes' position, type, value, and other data. The calculation may employ a hash algorithm to realize a fixed length format, and to provide a relatively short and easily compared value. The fingerprints can be persisted for each process instance. In some instances, changes on affected and relevant attributes can trigger and force a recalculation to perform a persistency update. In some implementations, a message is received at a web service end point associated with a BPMS and/or one or more business process instances. Relevant message attributes can be extracted from the received messages for calculations of the corresponding message fingerprints. The calculated message fingerprints are then compared with fingerprints of the process context. If the message fingerprints match the process context fingerprints, then the message is received by the matching process instance associated with the process context fingerprint, otherwise it is discarded if no matches are found. When the control flow of the process instance reaches the IME (e.g., in a case where the process context fingerprints are updated), the fingerprint of the message and the process context are compared again to ensure continued correlation. If the fingerprints still match, then the message is consumed.

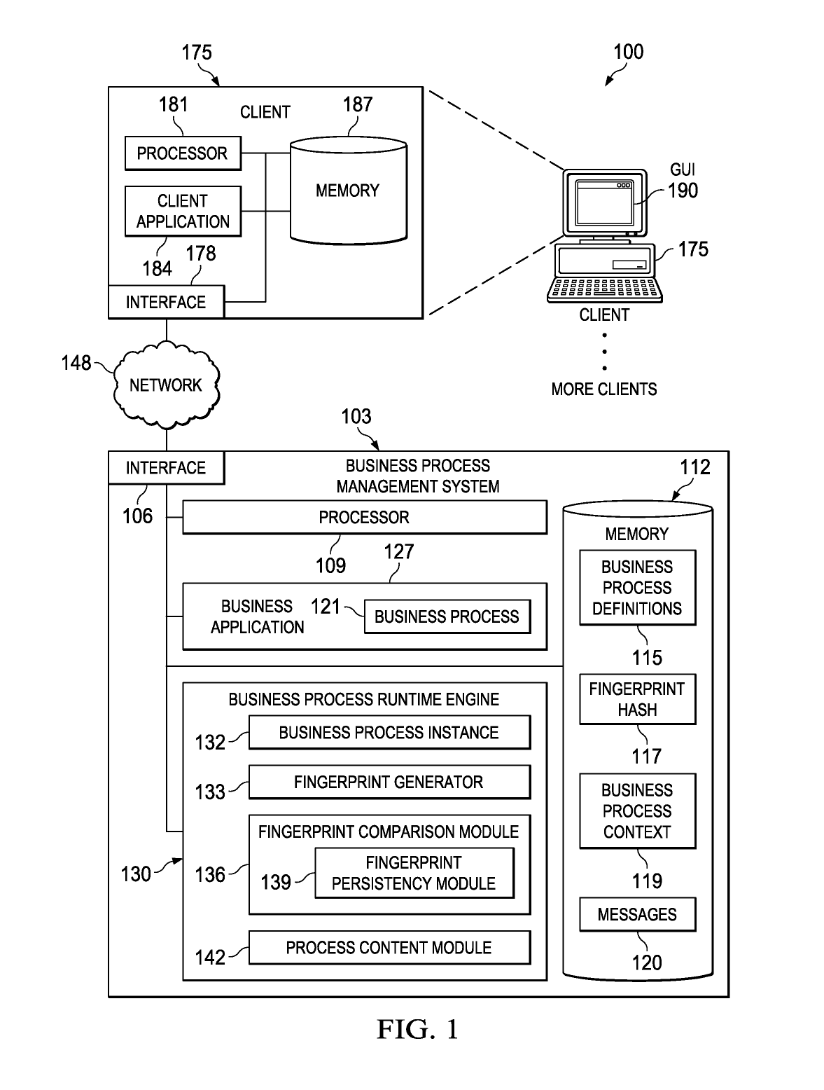

FIG. 1 illustrates an example environment 100 for implementing various features of a system for correlating messages in a business process management system. The illustrated environment 100 includes, or is communicably coupled with, a client 175, and a business process management system 103. At least some of the communications between the business process management system 103 and the client 175 may be performed across or via network 148. In general, environment 100 depicts an example configuration of a system for receiving messages from the client 175 at the business process management system 103. For example, the business process management system 103 can provide applications, processing resources, and/or database to the client 175 (e.g., to support client applications 184). The environment 100 is an example, and in alternative implementations, the elements illustrated in FIG. 1 may be included in or associated with different and/or additional servers, clients, networks, and locations other than those as shown. For example, there are usually additional clients sending messages to the business process management system 103. For example, multiple clients can be connected to one or more business process management systems similar to the business process management system 103 to obtain various functionalities and services. That is, one or more of the components illustrated within the business process management system 103, the client 175, or any of the other illustrated components, may be located in multiple or different servers, cloud-based networks, or other locations accessible to the business process management system 103 (e.g., either directly or indirectly via network 148).

At a high level, the business process management system 103 can be connected with one or more clients such as the client 175. For example, the business process management system 103 can receive messages from the client 175. The messages can be correlated with process context using a business process runtime engine 130 in the business process management system 103. Once correlated, the message sent from the client 175 can be consumed at the business process management system 103, such as, for example, values carried in the message applied to the business application 127 of the business process management system 103. In some instances, messages may be received at the business process management system 103 from systems other than clients 175, such as other internal systems assisting in the performance and completion of various business processes.

In the illustrated implementation of FIG. 1, the business process management system 103 includes an interface 106, a processor 109, memory 112, the business application 127, and the business process runtime engine 130. In some instances, the business process management system 103 and its illustrated components may be separated into multiple components executing at different servers and/or systems. For example, while FIG. 1 illustrates the business application 127 and the business process runtime engine 130 as separate components, other example implementations can include the business process runtime engine 130 within a separate system, as well as within as part of the business application 127's inherent functionality. Thus, while illustrated as a single component in the example environment 100 of FIG. 1, alternative implementations may illustrate the business process management system 103 as including multiple parts or portions, accordingly.

The interface 106 is used by the business process management system 103 to communicate with other systems in a client-server or other distributed environment (including within environment 100) connected to the network 148 (e.g., the client 175, as well as other systems communicably coupled to the network 148). The interface 106 generally includes logic encoded in software and/or hardware in a suitable combination and operable to communicate with the network 148. More specifically, the interface 106 may include software supporting one or more communication protocols associated with communications such that the network 148 or the interface hardware is operable to communicate physical signals within and outside of the illustrated environment 100.

The processor 109 can be any appropriate processing unit or units to enable computation in the business process management system 103. Although illustrated as a single processor 109 in the business process management system 103, two or more processors may be used in the business process management system 103 according to particular needs, desires, or particular embodiments of environment 100. The processor 109 may be a central processing unit (CPU), a blade, an application specific integrated circuit (ASIC), a field-programmable gate array (FPGA), or another suitable component. Generally, the processor 109 executes instructions and manipulates data to perform the operations of the business process management system 103 and, specifically, the functionality associated with the corresponding business application 127 and the business process runtime engine 130. In one implementation, the server's processor 109 executes the functionality required to receive inbound communications from and send outbound communications to the client 175, as well as the functionality required to perform the operations of the associated business application 127 and the business process runtime engine 130, among others.

The memory 112 of the illustrated business process management system 103 stores at least a database or other storage for business process definitions 115, fingerprint hashes 117 generated by the business process runtime engine 130, business process contexts 119, messages 120 received from the client 175, and other data and program instructions. The memory 112 may include any memory or database module and may take the form of volatile or non-volatile memory including, without limitation, magnetic media, optical media, random access memory (RAM), read-only memory (ROM), removable media, or any other suitable local or remote memory component. The memory 112 may store various objects, object models, and data, including classes, frameworks, applications, backup data, business objects, jobs, web pages, web page templates, database tables, process contexts, repositories storing services local to the business process management system 103, and any other appropriate information including any parameters, variables, algorithms, instructions, rules, constraints, or references associated thereto with the purposes of the business process management system 103 and its functionality. In some implementations, including a cloud-based system, some or all of the memory 112 may be stored remote from the business process management system 103, and communicably coupled to the business process management system 103 for usage. Specifically, memory 112 can store business process runtime engine 130. Some or all of the elements illustrated within memory 112 may be stored external to the memory 112. These items are made accessible to the business process runtime engine 130. The memory 112 includes the business process definitions 115 modeled with an intermediate message event (IME). The business process definitions 115 can be associated with the business processes 121 in the business application 127. The memory 112 also includes the fingerprint hashes 117 generated for both the incoming messages 120 and the process context 119. The business process contexts 119 can be associated with one or more business process instances 132 in the business process management system 103, and can be stored in the memory 112. Process contexts 119 can be modified during the execution of the various business process instances 132 in response to changing variables, events, and other actions. The incoming messages 120 from client 175 and other multiple clients can be stored, sometimes temporarily, in the memory 112. The information stored in the memory 112 can support operations of the business application 127 as well as the business process runtime engine 130.

At a high level, the business application 127 can be any application, program, module, process, or other software that may execute, change, delete, generate, or otherwise manage information associated with a particular business process management system 103. In particular, the business application 127 may be associated with one or more business processes that communicate with other users, applications, systems, and components to send, receive, and process events. In some instances, a particular business application 127 may operate in response to and in connection with one or more requests received from an associated client 175 or other remote client. Additionally, a particular business application 127 may operate in response to and/or in connection with one or more requests received from other applications external to the business process management system 103. In some instances, the business application 127 may request additional processing or information from an external system or application. In some instances, one or more of the applications may represent a web-based application accessed and executed by remote clients 175 via the network 148 (e.g., through the Internet, or via one or more cloud-based services associated with the business application 127). Further, while illustrated as internal to the business process management system 103, one or more processes associated with a particular application 127 may be stored, referenced, or executed remotely. For example, a portion of a particular application 127 may be a web service that is remotely called, while another portion of the business application 127 may be an interface object or agent bundled for processing at a remote system (not illustrated), or a particular client 175 (e.g., the client application 184). Moreover, any or all of a particular application 127 may be a child or sub-module of another software module or enterprise application (not illustrated) without departing from the scope of this disclosure. Still further, portions of the particular application 127 may be executed or accessed by a user working directly at the business process management system 103, as well as remotely at a corresponding client 175.

The business process runtime engine 130 can provide message correlation by examining correlation conditions, and can generally perform the runtime operations required to perform one or more business processes 121 associated with the various business process instances 132. The business process runtime engine 130 includes or is associated with one or more businesses process instances 132, a fingerprint generator 133, a fingerprint comparison module 136, and a process context module 142. The business process instance 132 can be associated with the business process 121 of the business application 127. For example, the business process instance 132 can be an instantiation of the business process 121. The fingerprint generator 133 can be an internal algorithm for calculating and generating fingerprints based on attributes of the messages 120 as well as for calculating and generating fingerprints of the process context. In some implementations, the fingerprint algorithm uses a hash algorithm to generate fingerprint hashes of a predefined length after an initial fingerprint is generated. The fingerprint comparison module 136 can examine and compare the fingerprints, or fingerprint hashes, of incoming messages to the fingerprint hashes of the process contexts identified by the process context module 142. The fingerprint comparison module 136 can further include a fingerprint persistence module 139 that is constantly, periodically, or frequently monitoring changes and updating fingerprint hashes of the process context. For example, the fingerprint persistence module 139 can persist an updated fingerprint hash for determining the correlation condition between the message fingerprint hash and the process context fingerprint hash. The message can be consumed at the business application 127 if the message correlation satisfies matching criteria through the sequence flow.

In general, the business process runtime engine 130 can identify relevant attributes of the messages 120 and the process contexts 119 of the business process management system 103. The business process runtime engine 130, or one of its components or modules, can place the identified attributes into an ordered and typed structure. The structure can subsequently be serialized. The fingerprint generator 133 can then calculate the fingerprints based on the serialized format of the attributes, for example, using a hash algorithm. The fingerprints can be used to identify the correlation condition. In some implementations, the serialized format of the attribute may be like the following:

<fingerprint>

<attribute position=“ attribute.position” type=“ [attribute.type] ”

>[attribute.value]</attribute>
<attribute position=“ attribute.position” type=“ [attribute.type]”
>[attribute.value]</attribute>

<attribute position=“ attribute.position type=“ [attribute.type]”

>[attribute.value]</attribute>
...
</fingerprint>

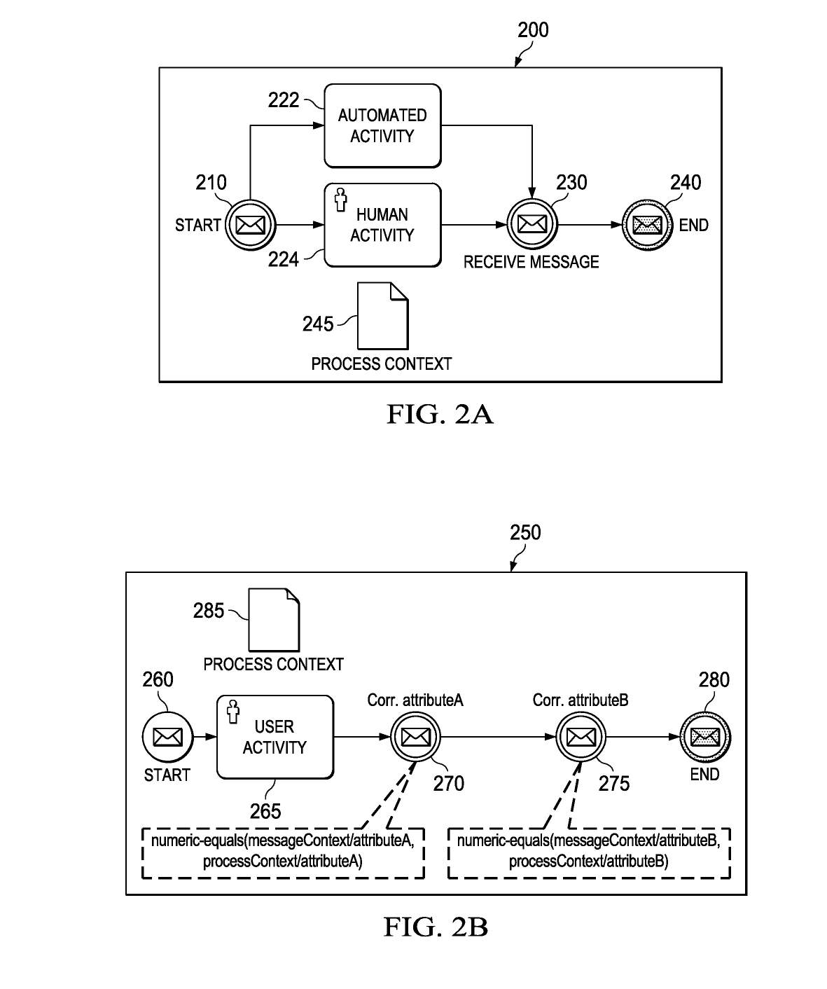

The serialization can be handled by a self-contained implementation, for example, external libraries may not be required for changing the serialized format or the fingerprint calculation. The serialized format can be maintained constant over time. This is for consistency and allowing the updated fingerprint hashes match to pre-calculated fingerprint hashes for the same attributes. More fingerprint generation examples are described in FIGS. 2A and 2B. In some implementations, the process communication in a business process management system 103 can be realized using web services. When a web service message is sent to the business process management system, relevant attributes can be extracted for correlation calculation. The attribute extraction process can be realized at the fingerprint generator 133 (e.g., extracting from the message context and the process context), the fingerprint persistency module 139 (e.g., checking any changes occurred to the attributes), and the process context module 142 (e.g., extracting attributes from the process context).

In general, the business process management system 103 is any server or system that stores, manages, and executes functionality associated with the business application 127 and the business process runtime engine 130. Additionally, the business process management system 103 may execute one or more applications 127. For example, each business process management system 103 may be a Java® 2 Platform, Enterprise Edition (J2EE)-compliant application server that includes Java® technologies such as Enterprise JavaBeans® (EJB), J2EE Connector Architecture (JCA), Java® Messaging Service (JMS), Java® Naming and Directory Interface (JNDI), and Java® Database Connectivity (JDBC). In some instances, each business process management system 103 may store a plurality of various applications; while in other instances, the business process management system 103 may be a dedicated server meant to store and execute the business process runtime engine 130 for a particular platform or application and its related functionality. In some instances, the business process management system 103 may include a web server or be communicably coupled with a web server, where one or more of the applications 127 associated with the business process management system 103 represent web-based (or web-accessible) applications accessed and executed through requests and interactions received by the client 175, executing a client application 184 operable to interact with programmed tasks or one or more applications 127.

The business process management system 103 can include an electronic computing device operable to receive, transmit, process, store, or manage data and information associated with the environment 100. The business process management system 103 illustrated in FIG. 1 can be responsible for receiving application-related requests from one or more clients 175 (as well as any other entity or system interacting with the business process management system 103, including desktop or mobile client systems), responding to the received requests by processing said requests in the associated application 127, and sending the appropriate responses from the appropriate component back to the requesting client 175 or other requesting system. Components of the business process management system 103 can also process and respond to local requests from a user locally accessing the server 103. Accordingly, in addition to requests from the client 175 illustrated in FIG. 1, requests associated with a particular component may also be sent from internal users, external or third-party customers, and other associated business applications, business processes, as well as any other appropriate entities, individuals, systems, or computers. In some instances, the business application 127 or the client application 184 may be web-based applications executing functionality associated with a networked or cloud-based business process.

Referring now to the client 175 illustrated in FIG. 1, the client 175 may be any computing device operable to connect to or communicate with the business process management system 103 using a wireline or wireless connection directly or via the network 148, or another suitable communication means or channel. In some instances, the client 175 may be a part of or associated with a business process involving one or more of a remote developer or user associated with the business application 127, for example, the client application 184. It will be understood that there may be any number of clients 175 associated with, or external to, environment 100. For example, while illustrated environment 100 includes a client 175, alternative implementations of environment 100 may include multiple sellers or customers communicably coupled to the one or more of the systems illustrated. In some instances, one or more clients 175 may be associated with administrators of the environment, and may be capable of accessing and interacting with the settings and operations of the business process runtime engine 130, one or more applications 127, and/or other components of the illustrated environment 100. Additionally, there may also be one or more additional clients 175 external to the illustrated portion of environment 100 capable of interacting with the environment 100 via the network 148.

The client 175 includes at least an interface 178, a processor 181, the client application 184, and a memory 187. The processor 181 performs analysis and data extraction related to the client application 184. Although illustrated as a single processor 181 in the client 175, two or more processors may be used in the client 175 according to particular needs, desires, or particular embodiments of environment 100. The processor 181 may be a central processing unit (CPU), a blade, an application specific integrated circuit (ASIC), a field-programmable gate array (FPGA), or another suitable component. Generally, the processor 181 executes instructions and manipulates data to perform the operations of the client 175 and, specifically, the functionality associated with the client application 184.

The memory 187 of the client 175 stores data and program instructions, rules associated with inbound and/or outbound communication. The memory 187 may include any memory or database module and may take the form of volatile or non-volatile memory including, without limitation, magnetic media, optical media, random access memory (RAM), read-only memory (ROM), removable media, or any other suitable local or remote memory component. The memory 187 may store various objects, object models, and data, including classes, frameworks, applications, backup data, business objects, jobs, web pages, web page templates, database tables, process contexts, repositories storing services local to the client 175, and any other appropriate information including any parameters, variables, algorithms, instructions, rules, constraints, or references thereto associated with the client 175 and its functionality. In some implementations, including a cloud-based system, some or all of the memory 187 may be stored remote from the client 175, and communicably coupled to the client 175 for usage. Some or all of the elements may be stored external to the memory 187, for example, in an internet-based storage location.

The GUI 190 associated with the client 175 includes a graphical user interface operable to, for example, allow the client 175 to interface with at least a portion of the client application 184, and/or the associated operations and functionality. Generally, the GUI 190 provides the particular user with an efficient and user-friendly presentation of business data provided by or communicated within the system. The GUI 190 may include a plurality of customizable frames or views having interactive fields, pull-down lists, and buttons operated by the user. For example, the GUI 190 may provide interactive elements that allow a user to interact with a particular component within and/or external to environment 100. Different portions of the corresponding component's functionality may be presented and accessible to the user through the GUI 190, such as through the client application 184 (e.g., a web browser). Generally, the GUI 190 may also provide general interactive elements that allow a user to access and utilize various services and functions of a particular component. In some instances, the client application 184 may be used to access various portions of the business process management system 103. In some instances, the client application 184 may be an agent or client-side version of the business application 127 or other suitable component of the business process management system 103. The GUI 190 may present the information of the client application 184 for viewing and interaction. In general, the GUI 190 is often configurable, supports a combination of tables and graphs (bar, line, pie, status dials, etc.), and is able to build real-time portals, where tabs are delineated by key characteristics (e.g., site or micro-site). Therefore, the GUI 190 contemplates any suitable graphical user interface, such as a combination of a generic web browser, intelligent engine, and command line interface (CLI) that processes information in the platform and efficiently presents the results to the user visually.

As used in this disclosure, each client 175 is intended to encompass a personal computer, touch screen terminal, workstation, network computer, kiosk, wireless data port, smart phone, personal data assistant (PDA), one or more processors within these or other devices, or any other suitable processing device. For example, each client 175 may include a computer that includes an input device, such as a keypad, touch screen, mouse, or other device that can accept user information, and an output device that conveys information associated with the operation of one or more client applications 184, and/or the client 175 itself, including digital data, visual information, or the GUI 190. Both the input and output device may include fixed or removable storage media such as a magnetic storage media, CD-ROM, or other suitable media, to both receive input from and provide output to users of client 175 through the display, namely, the GUI 190. The client's processor 181, interface 178, and memory 187 may be similar to or different from those described in connection with the other components illustrated in FIG. 1, although alternative implementations of one or more of these components may be used, as well as implementations where additional components may also be included.

FIG. 1 depicts a server-client environment, but could also represent a cloud computing network. Various other implementations of the illustrated environment 100 can be provided to allow for increased flexibility in the underlying system, including multiple application systems 103 performing or executing one or more additional or alternative instances of the business process runtime engine 130 for one or more different platforms, as well as multiple instances of the business application 127 and its related functionality. In those instances, the different application systems 103 may communicate with each other via a cloud-based network or through the connections provided by network 148. Generally, the business process management system 103 may be communicably coupled with the network 148 that facilitates wireless or wireline communications between the components of the environment 100 (i.e., between the business process management system 103 and one or more clients 175), as well as with any other local or remote computer, such as additional clients, servers, or other devices communicably coupled to the network 148, including those not illustrated in FIG. 1. In the illustrated environment, the network 148 is depicted as a single network, but may be included in more than one network without departing from the scope of this disclosure, so long as at least a portion of the network 148 may facilitate communications between senders and recipients. In some instances, one or more of the components associated with the business process management system 103 may be included within the network 148 as one or more cloud-based services or operations.

The network 148 may be all or a portion of an enterprise or secured network, while in another instance, at least a portion of the network 148 may represent a connection to the Internet. In the illustrated example, at least a portion of the network 148 includes a portion of a cellular or mobile data network or other network capable of relaying SMS messages. In some instances, a portion of the network 148 may be a virtual private network (VPN). Further, all or a portion of the network 148 can include either a wireline or wireless link. Example wireless links may include 802.11/b/g/n, 802.20, WiMax®, and/or any other appropriate wireless link. In other words, the network 148 encompasses any internal or external network, networks, sub-network, or combination thereof operable to facilitate communications between various computing components inside and outside the illustrated environment 100. The network 148 may communicate with, for example, Internet Protocol (IP) packets, Frame Relay frames, Asynchronous Transfer Mode (ATM) cells, voice, video, data, and other suitable information between network addresses. The network 148 may also include one or more local area networks (LANs), radio access networks (RANs), metropolitan area networks (MANs), wide area networks (WANs), all or a portion of the Internet, and/or any other communication system or systems at one or more locations.

As used in this present disclosure, the term “computer” is intended to encompass any suitable processing device. For example, although FIG. 1 illustrates a single business process management system 103, environment 100 can be implemented using any number of servers, as well as computers other than servers, including a server pool. Indeed, the business process management system 103 may be any computer or processing device such as, for example, a blade server, general-purpose personal computer (PC), Macintosh®, workstation, UNIX®-based workstation, or any other suitable device. In other words, the present disclosure contemplates computers other than general purpose computers, as well as computers without conventional operating systems. Further, the illustrated business process management system 103 may be adapted to execute any operating system, including Linux®, UNIX®, Windows®, Mac® OS, iOS, or any other suitable operating system.

Regardless of the particular implementation, “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java®, Visual Basic®, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, each processor 109 executes the corresponding business process runtime engine 130 and the business application 127 stored on the associated business process management system 103. In some instances, a particular business process management system 103 may be associated with the execution of two or more applications 127 (and other related components), as well as one or more distributed applications executing across two or more servers executing the functionality associated with the business process management system 103.

FIGS. 2A and 2B illustrate example business process models of business process instances. Referring first to FIG. 2A, the business process model 200 includes a process start 210, an automated activity 222, a human activity 224, a intermediate message event 230, and an end event 240. The business process model 200 may have a process context definition provided by the process context 245. For example, the process context 245 can be associated with a process definition modeled with an intermediate message event. The intermediate message event may define structures of incoming messages (e.g., the format of the messages, such as XML schema, web service description language, etc.). The intermediate message even may also define one or more correlation conditions used for message consumption determination.

The business process model 200 can have a sequence flow starting at the process start 210 where the business process is initiated, for example, executing a business application. The process start 210 can be followed with human activities/interaction 224, and/or automated activities 222. For example, in a business process, human users (e.g., such as the client 175 in FIG. 1) may interact with the business process and generate input data or send messages. In some implementations, automated event 222 may replace or assist, or work in parallel with, the human activities 224 (e.g., using computer programs to generate repetitive/mechanistic input). The input generated by the human activities 224 and the automated activities 222 can be stored in the process context and used at the intermediate message event 230 to compare values of the message with values of the process context (e.g. in the correlation condition). The correlation condition of the intermediate message event at the intermediate message event 230 may look like the following:

string-equals(messageContext/attributeA, processContext/attributeA) &&
numeric-equals(messageContext/attributeB, processContext/attributeB)

Based on the correlation condition defined at the intermediate message event, the system can identify the correlation attributes that are relevant for correlation. For example, the attributes of a process instance can include:

cor0: (String) <value of processContext/attributeA>
cor1: (Integer) <value of processContext/attributeB>

The attributes of a web service message can include:

cor0 = (String) <value of messageContext/attributeA>
cor1 = (Integer) <value of messageContext/attributeB>

Besides the position, the type and the value, the correlation condition may also include the information on how the individual conditions are logically combined (in this example with a logical “AND”). The requirement for a valid correlation may include a match between the process and web service message in terms of attribute values, type and position, as well as individual conditions to be evaluated to be true for fulfilling the correlation condition for this intermediate message event. In the given example above, cor0 AND cor1 are required to be evaluated to be true.

This logical combination can also be reflected in the fingerprint of the process instance and the web service message. Individual conditions combined with a logical AND can therefore be serialized into one fingerprint. For each process instance started for this process definition the following serialized format can be generated (i.e., in this example, cor<position> is replaced with <position>, abc and 123 are example values of the attributes in the process context):

<fingerprint>

<attribute position=“0”type=“STRING”>abc</attribute>
<attribute position=“1”type=“INTEGER”>123</attribute>

</fingerprint>

In this example, calculating a fingerprint hash value over this string of the process context leads to a 32-digit value, as follows:

Hash: 12345678901234567890123456789012

The calculation for the fingerprint hash of the web service message generates a value of the same length (32-digit). If a message is received at the endpoint 230 that the process instance is listening to, the system of the process model 200 can check whether the correlation condition is true by comparing the fingerprints or fingerprint hashes of the process context and the message. The fingerprints and fingerprint hashes are comparable because they are calculated using the same algorithm. For example:

<fingerprint>

<attribute position=“0”type= “STRING”>abc</attribute>
<attribute position=“1”type=“INTEGER”>123</attribute>

</fingerprint>

Hash: 12345678901234567890123456789012

In this example, because the position, type and value of the correlation attributes are equal for both the process context and the web service message context, both fingerprints are equal and the web service message can be correlated with the process instance.

The following describes another example where correlation conditions are not valid due to different fingerprint hash values. The process context and web service message can be the same as the previous example:

string-equals(messageContext/attributeA, processContext/attributeA) &&
numeric-equals(messageContext/attributeB, processContext/attributeB)

The attributes of a process instance can include:

cor0: (String) <value of process Context/attributeA>
cor1: (Integer) <value of processContext/attributeB>

The attributes of a web service message can include:

cor0 = (String) <value of messageContext/attributeA>
cor1 = (Integer) <value of messageContext/attributeB>

Logical combination:

cor0 AND cor1

### Process Instance

<fingerprint>

<attribute position=“0”type=“STRING”>abc</attribute>
<attribute position=“1”type=“INTEGER”>123</attribute>

</fingerprint>
Hash: 12345678901234567890123456789012

Web Service Message (note the different value)<

<fingerprint>

<attribute position=“0”type=“STRING”>xyz</attribute>
<attribute position=“1”type=“INTEGER”>123</attribute>

</fingerprint>

Hash: 58698756548523215478856258963148

In this second example, because the value of attributeA in the web service message is not the same as in the process context, the fingerprint hash is different and no correlation is happening.

A third example that does not correlate because of a different attribute type can be as follows:

### Process Instance

<fingerprint>

<attribute position=“0”type=“BOOLEAN”>true</attribute>
<attribute position=“1”type=“INTEGER”>123</attribute>

</fingerprint>
Hash: 23456789012345678901234567890123

### Web Service Message

<fingerprint>

<attribute position=“0”type=“STRING”>true</attribute>
<attribute position=“1”type=“INTEGER”>123</attribute>

</fingerprint>

Hash: 865789453521258965478953213652347

In this third example, because the type of attributeA in the web service message is different from the one in the process context, the fingerprint hash is different and no correlation is happening.

Turning now to FIG. 2B, an example business process model 250 describing a possible correlation failure due to a different position is provided. As illustrated in FIG. 2B, the business process model 250 can include two or more intermediate message events 270 and 275, as well as the process start 260, user activities 265, and an end event 280. The process context 285 for process instances of the business process model 250 are persisted and compared to the messages received at the two intermediate message events. The correlation conditions associated with the two intermediate message events (IMEs) 270 and 275 can be as follows:

IME 1

numeric-equals(messageContext/attributeA, processContext/attributeA)

IME 2

numeric-equals(messageContext/attributeB, processContext/attributeB)

Similar to the previous examples, attributes of the incoming message can be described as:

Process Instance

cor0: (Integer) <value of processContext/attributeA>
cor1: (Integer) <value of processContext/attributeB>

Web Service Message

cor0 = (Integer) <value of messageContext/attributeA>
cor1 = (Integer) <value of messageContext/attributeB>

In this example the correlation conditions used in this process definition are logically combined with an “OR” which means that a message should be correlated with the intermediate message event when one of these correlation conditions evaluate to true. The generation of the fingerprints can therefore be different from in the examples before. For each correlation conditions disjoined by a logical OR, a fingerprint hash can be generated, for example:

Process Instance

Intermediate Message Event “Corr. attributeA”

<fingerprint>

<attribute position= “0”type= “INTEGER ”>123</attribute>

</fingerprint>
Hash: 34567890123456789012345678901234

Intermediate Message Event “Corr. attributeB”

<fingerprint>

<attribute position=“1”type=“INTEGER”>123</attribute>

</fingerprint>

Hash: 45678901234567890123456789012345

If a message with attributeB=123 is received, it can be matched with the intermediate message event “Corr. attributeB”, not with the intermediate message event “Con. attributeA”. Because the position is considered for calculating the hash, it can ensure that “Con. attributeA” does not correlate even though it has same value and type. For example:

Web Service Message

<fingerprint>

<attribute position=“1”type=“INTEGER”>123</attribute>

</fingerprint>

Hash: 45678901234567890123456789012345

In some implementations, if both correlation conditions refer to the same correlation attribute (e.g. cor0) then the position attribute would be identical and the hash would be the same. This basically means that both conditions would be able to consume the message, but only the one that is reached first in the process flow will actually consume it. A further example is described in FIG. 6.

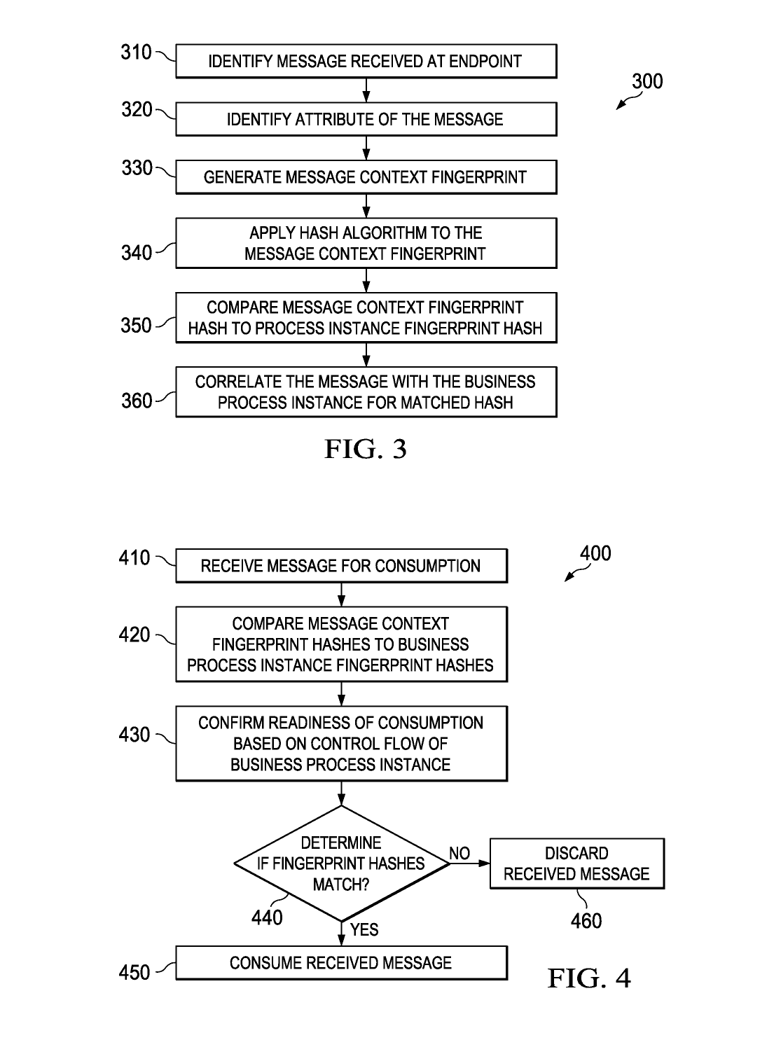

FIG. 3 illustrates an example method 300 for correlating messages. At 310, an incoming message is received at an endpoint of a business process. The endpoint can be associated with at least one business process instance. The endpoint can be listened to or monitored by a business process management system determining if any new messages are received. In some implementations, the structure of each received message can be known, as the structure is defined by the intermediate message event at design time. At 320, at least one attribute of the incoming message is identified as part of a defined set of relevant attributes associated with a correlation condition of a business instance. The correlation attributes may be generated at compilation time when relevant portions of messages and process context are defined. In some implementations, the correlation condition information can be stored in a table at the business process runtime engine, such as the business process runtime engine 130 of FIG. 1. The relevant attributes can be extracted from the incoming messages based on certain pre-defined priorities for each particular business process instance, with those relevant attributes used to create a message context fingerprint.

At 330, a message context fingerprint is generated. The fingerprint can include at least one identified attribute of the incoming message. The message context fingerprint can be placed into a uniform and predetermined format or structure. In some implementations, the fingerprint can include values and positions of the attributes. At 340, a hash algorithm can be applied to the message context fingerprint to create a message context fingerprint hash. The message fingerprint hash can uniquely associate with at least one identified attribute of the message. In general, any suitable hashing algorithm may be used to calculate the fingerprint hash. The same hashing algorithm is used to calculate the fingerprint hash of the process context using the relevant attributes as defined in the process context of the business process instance.

At 350, the message context fingerprint hash is compared with the process instance fingerprint hash that is calculated using the same hash algorithm. In some instances, the process context fingerprint hashes associated with a particular business process instance may be stored in a relational database, such as the fingerprint hash 117 of FIG. 1. The fingerprint hashes may be updated when any changes in the attributes are detected or observed. A new, updated fingerprint hash will be calculated if changes are detected, for example, using the fingerprint persistence module 139 of FIG. 1. At 360, in response to a determination that the fingerprint hashes of the message match with the fingerprint hashes of the process context, the message associated with the message context fingerprint is associated with the business process instance associated with the matching hashed business process instance fingerprint. For example, the association can include sending the message to the corresponding business process instance to be consumed when the business process instance is processing. Otherwise, if a match is not found, the message can be discarded.

FIG. 4 illustrates an example method 400 for determining whether a message is to be consumed by a business process instance. The method 400 can determine, prior to consumption, if the business process instance fingerprint matches the message fingerprint if some attribute values are changed. At 410, a message is received for future consumption based on the message having a message context fingerprint associated with a business process instance fingerprint. At 420, the message context fingerprint is compared to the current business process instance fingerprint to confirm a match between the message fingerprint and the process context fingerprint. For example, the current business process instance fingerprint may be the same as it was calculated in the first comparison. Or the current business process instance fingerprint may have changed based on a modification to the process context of the business process instance. In response to the changes in the context, a new business process instance fingerprint will be calculated and hashed (e.g., persisted). At 430, the readiness of consumption is confirmed based on whether control flow is at the message-related action in the business process instance. If not, the sequence flow may return to wait for a positive confirmation. At 440, a second comparison is performed to determine if the fingerprints of the message match with the fingerprints of the process context. If the fingerprints of the two still match, then the message is consumed by the business process instance at 450; otherwise the message is discarded at 460.

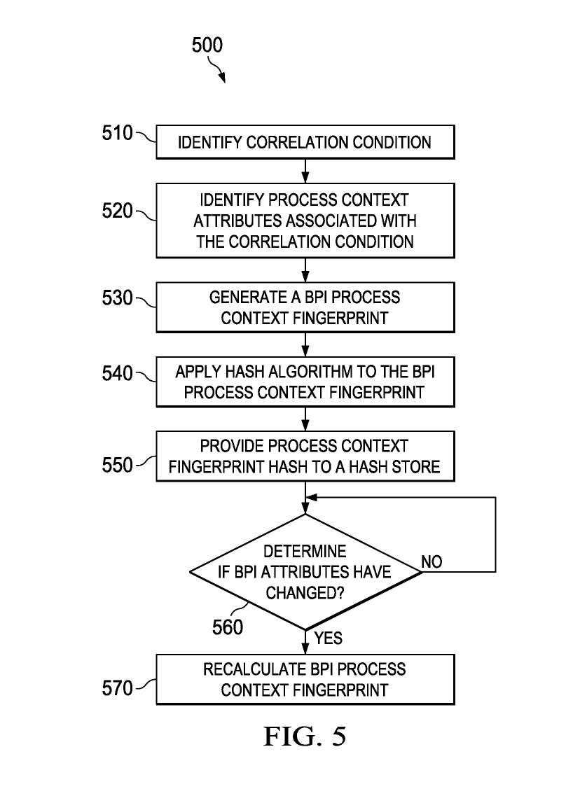

FIG. 5 illustrates an example method 500 for persisting process context fingerprint and generating the business process instance fingerprint. The method 500 can be used in association with a fingerprint generator, such as the fingerprint generator 133 of FIG. 1, to generate business process instance fingerprints. In some implementations, the method 500 may be tailored specifically for persisting fingerprints, such as in the fingerprint persistence module 139 of FIG. 1. At 510, a correlation condition is first identified. The correlation condition may be associated with a business process instance at instantiation of the business process (e.g., using the initial process context upon initiating the business process instance). At 520, at least one process context attribute associated with the correlation condition is identified. These operations may be executed for each instance at instantiation of the business process, where the correlation attributes are initially extracted from the process context. At 530, a business process context fingerprint is generated, the business process context fingerprint including at least one identified process context attribute relevant to the correlation condition. The fingerprints may include position, type, value, and other information related to the attributes relevant to the correlation condition. At 540, a hash algorithm is applied to the business process context fingerprint to create a process context fingerprint hash for comparison with the message fingerprint hash. The hash algorithm applied to both the message and the process context is the same and generates hashes of the same format (e.g., of same length).

At 550, the generated process context fingerprint hash is provided to a hash store, such as the fingerprint hash 117 of memory 112 in FIG. 1. The generated process context fingerprint hash may be used to first compare with the message fingerprint hash, such as when the message is initially received at an intermediate message event. At 560, the business process instance attributes are examined for changes to determine if a recalculation of a new fingerprint hash is required. If the attributes remain unchanged, then no recalculation is required. In those instances, the sequence flow may periodically, or in response to an event, return to 560 to determine if the relevant business process instance attributes have changes. If the business process instance attributes have changed, then the business process instance process context fingerprint is recalculated and the fingerprint hash is updated at 570.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different order than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method for managing system alert incidents, comprising:
identifying a message received at an end point associated with at least one executing business process instance;
identifying at least one attribute of the identified message associated with a defined set of relevant attributes associated with a correlation condition of at least one business process instance associated with the end point;
generating a message context fingerprint containing the at least one identified attribute of the identified message;
applying a hash algorithm to the message context fingerprint to create a message context fingerprint hash, the message context fingerprint hash uniquely associated with the at least one identified attribute of the identified message;
comparing the message context fingerprint hash to a plurality of business process instance fingerprint hashes of a corresponding plurality of business process instances associated with the end point; and
correlating the identified message associated with the message context fingerprint hash with the business process instance associated with the matching hashed business process instance fingerprint hash.

2. The computer-implemented method of claim 1, further comprising sending the message to the corresponding business process instance for consumption.

3. The computer-implemented method of claim 1, further comprising:
receiving the message at a corresponding business process instance;
in response to a determination that the control flow of the corresponding business process instance is ready to consume the message, comparing the message context fingerprint hash of the message to the current business process instance fingerprint hash of the corresponding business process instance to confirm a match; and
consuming, in response to a determination that a match is confirmed, the message at the corresponding business process instance.

4. The computer-implemented method of claim 3, further comprising discarding the message in response to a determination that a match is not confirmed.

5. The computer-implemented method of claim 1, wherein the end point comprises a structure defined by an intermediate message event associated with a process definition.

6. The computer-implemented method of claim 2, wherein the payload of the received message is provided in an XML schema or web service description language.

7. The computer-implemented method of claim 1, wherein the correlation condition comprises equality conditions concatenated with a logical operator based on payload and context of the message.

8. The computer-implemented method of claim 1, wherein the defined set of relevant attributes are defined by rules for extracting data from the context of the received message.

9. The computer-implemented method of claim 1, further comprising initiating at least one business process instance, wherein the at least one business process provides input data used in the context of the message.

10. The computer-implemented method of claim 1, wherein the plurality of business process instance fingerprint hashes are generated into a predetermined format based at least on position, type, and value.

11. The computer-implemented method of claim 1, wherein at least one of the business process instance fingerprint hashes is defined upon instantiation of the at least one business process instance.

12. The computer-implemented method of claim 1, wherein at least one of the business process instance fingerprint hashes is recalculated during execution of the at least one business process instance in response to a change to a process context associated with the at least one business process instance.

13. A tangible, non-transitory computer-readable medium encoded with a computer program, the program comprising instructions that when executed by one or more computers cause the one or more computers to perform operations for correlating messages comprising:
identifying a message received at an end point associated with at least one executing business process instance;
identifying at least one attribute of the identified message associated with a defined set of relevant attributes associated with a correlation condition of at least one business process instance associated with the end point;
generating a message context fingerprint containing the at least one identified attribute of the identified message;
applying a hash algorithm to the message context fingerprint to create a message context fingerprint hash, the message context fingerprint hash uniquely associated with the at least one identified attribute of the identified message;
comparing the message context fingerprint hash to a plurality of business process instance fingerprint hashes of a corresponding plurality of business process instances associated with the end point; and
correlating the identified message associated with the message context fingerprint hash with the business process instance associated with the matching hashed business process instance fingerprint hash.

14. The computer-readable medium of claim 13, further comprising instructions that when executed by one or more computers cause the one or more computers to perform operations for correlating messages comprising sending the message to the corresponding business process instance for consumption.

15. The computer-readable medium of claim 13, further comprising instructions that when executed by one or more computers cause the one or more computers to perform operations for correlating messages comprising:
receiving the message at a corresponding business process instance;
in response to a determination that the control flow of the corresponding business process instance is ready to consume the message, comparing the message context fingerprint hash of the message to the current business process instance fingerprint hash of the corresponding business process instance to confirm a match; and
consuming, in response to a determination that a match is confirmed, the message at the corresponding business process instance.

16. The computer-readable medium of claim 15, further comprising instructions that when executed by one or more computers cause the one or more computers to perform operations for correlating messages comprising discarding the message in response to a determination that a match is not confirmed.

17. A system of one or more computers configured to perform operations for correlating messages comprising:
identifying a message received at an end point associated with at least one executing business process instance;
identifying at least one attribute of the identified message associated with a defined set of relevant attributes associated with a correlation condition of at least one business process instance associated with the end point;
generating a message context fingerprint containing the at least one identified attribute of the identified message;
applying a hash algorithm to the message context fingerprint to create a message context fingerprint hash, the message context fingerprint hash uniquely associated with the at least one identified attribute of the identified message;
comparing the message context fingerprint hash to a plurality of business process instance fingerprint hashes of a corresponding plurality of business process instances associated with the end point; and
correlating the identified message associated with the message context fingerprint hash with the business process instance associated with the matching hashed business process instance fingerprint hash.

18. The system of claim 17, further configured to perform operations comprising:
sending the message to the corresponding business process instance for consumption;
receiving the message at a corresponding business process instance;
in response to a determination that the control flow of the corresponding business process instance is ready to consume the message, comparing the message context fingerprint hash of the message to the current business process instance fingerprint hash of the corresponding business process instance to confirm a match; and
consuming, in response to a determination that a match is confirmed, the message at the corresponding business process instance.

19. The system of claim 18, further configured to perform operations comprising instructions that when executed by one or more computers cause the one or more computers to perform operations for correlating messages comprising discarding the message in response to a determination that a match is not confirmed.

20. The system of claim 17, further configured to perform operations comprising sending the message to the corresponding business process instance for consumption.
